(19) United States
(12) Patent Application Publication
(10) Pub. No.: US 2024/0351469 A1
(43) Pub. Date: Oct. 24, 2024

(54) DETECTION ARRANGEMENT, MOTOR VEHICLE AND METHOD FOR DETECTING A POSSIBLE FAULT IN AN ENERGY STORAGE OF A MOTOR VEHICLE

(71) Applicant: AUDI AG, Ingolstadt (DE)

(72) Inventors: Florian ACHHAMMER, lngolstadt (DE); Carsten LORENZ, Reichertshofen (DE); Paul SCHNEIDER, Großmehring (DE); Martin SCHÜSSLER, Kösching (DE)

(73) Assignee: AUDI AG, Ingolstadt (DE)

(21) Appl. No.: 18/631,305

(22) Filed: Apr. 10, 2024

(30) Foreign Application Priority Data
Apr. 20, 2023 (DE) 102023110109.9

(51) Int. Cl. B60L 58/10; B60L 50/60; B60L 50/64; H01M 10/42

(52) U.S. Cl. CPC B60L 58/10; B60L 50/64; B60L 50/66; H01M 10/4228

(57) ABSTRACT

A detection arrangement for detecting a possible fault of an energy storage device of a motor vehicle. The detection arrangement has an underride guard, a sensor arranged on or integrated into the same, and a control device for detecting at least two different possible fault cases including a possible first fault case and a possible second fault case, and for determining based on a measurement signal received from the sensor, whether the possible first or second fault case is present. At least one first reaction measure is assigned to the possible first fault case and at least one second reaction measure, which is different from the first, is assigned to the possible second fault case.

### FIELD

The invention relates to a detection arrangement for detecting a possible fault in an energy storage of a motor vehicle, wherein the detection arrangement comprises an underride guard, at least one first sensor arranged on the underride guard or integrated into the underride guard, and a control device which is designed to detect at least two different specific possible fault cases comprising detecting a possible first fault case and a possible second fault case and, depending on a measurement signal received by the at least one first sensor, determining whether the possible first fault case is present or whether the possible second fault case is present. Furthermore, the invention also relates to a motor vehicle with such a detection arrangement and a method for detecting a possible fault.

### BACKGROUND

Energy storages for motor vehicles, in particular high-voltage energy storages, are typically arranged in an underbody region of the motor vehicle, for example above an underride guard. Faults in such an energy storage device are typically detected using sensors that are integrated into such an energy storage device, for example temperature sensors, voltage sensors or similar. Nevertheless, it is also known from the prior art that deformations or intrusions through the underride guard can be detected by means of a suitable sensor system that can be arranged on it or can be integrated into it.

In this context, for example, DE 10 2020 126 565 A1 describes a vehicle with a high-voltage battery that is installed in a floor structure of the vehicle, wherein a road-side interference contour acts indirectly or directly on the high-voltage battery in the event of a ground contact, the underride guard of which is assigned a number of sensors, with the help of which, in the event of ground contact, the impact location of the road-side interference contour can be localized and the ground impact force acting on the underride guard can be detected, wherein the sensors are connected in terms of signaling to an evaluation unit, which detects possible damage to the high-voltage battery on the basis of the detected impact location and the detected ground impact force. The underride guard is divided into at least a first zone, which is of greater relevance to battery safety due to a statistical or empirical evaluation, and a second zone, which, in contrast, is of reduced relevance to battery safety. A sensor with increased sensitivity is assigned to the first zone with increased safety relevance, while a sensor with reduced sensitivity is assigned to the second zone. This means that the costs and production effort for sensor assembly can be limited in a targeted manner in the zone with reduced safety relevance.

### SUMMARY

The object of the present invention is to provide a detection arrangement, a motor vehicle and a method which allow more intelligent handling of detected possible faults in an energy storage device.

A detection arrangement according to the invention for detecting a possible fault in an energy storage unit of a motor vehicle comprises an underride guard, at least one first sensor arranged on the underride guard or integrated into the underride guard, a control device which is designed to detect at least two different specific possible fault cases comprising a possible first fault case and a possible second fault case and, depending on a measurement signal received by the at least one first sensor, to determine whether the possible first fault is present or whether the possible second fault is present. At least one first reaction measure is assigned to the possible first fault case and at least one second reaction measure is assigned to the possible second fault case, which differs from the first reaction measure, wherein the control device is designed to initiate the first reaction measure if the control device has determined that the possible first fault case is present, and to initiate the second reaction measure if the control device has determined that the possible second fault case is present.

The invention is based on the knowledge that the possibility of distinguishing between different fault cases can be used to trigger and initiate significantly more adapted reaction measures. In other words, the same measure does not have to be initiated for every detected fault. For example, it is not necessary to completely deactivate the high-voltage on-board electrical system and the battery system in the event of a very minor fault. Sensors integrated into an underride guard enable a much more differentiated consideration of fault cases. For example, deformations of the underride guard or even intrusions of objects into the underride guard and, for example, also into the battery, as an example of the energy storage, can be easily detected. Such an intrusion can thus be detected much earlier than, for example, its consequences, such as a rise in temperature of thermally damaged cells, which will only become apparent some time later. Above all, the measurement signals that are provided by the sensors integrated into the underride guard can also be evaluated in conjunction with the measurement variables recorded within the energy storage, which also enables significantly more reliable detection of faults, for example due to redundant measurement results from different sensors, and a significantly more differentiated consideration of fault cases is permitted by comparing the measurement results of different signals. Overall, this makes it possible to initiate measures in the event of possible faults much more intelligently and earlier and thus proactively tailor the type of measures much better to the type and/or severity of the fault cases. This means that even more serious subsequent faults can be prevented by taking more appropriate and less drastic measures at an early stage.

The fact that the control device is designed to detect several possible fault cases should be understood to mean that such a fault case does not necessarily have to actually be present if it is detected by the control device as a possible fault case. For example, a specific possible fault case can be considered to be detected if the probability that this fault case occurs exceeds a predeterminable limit value and/or if one or more indications of such a fault case are present. Even if not every fault case is referred to below as a possible fault case, a fault case in the context of the present invention should be understood to mean not only an actual fault or fault case, but also a possible fault, that is, a potential fault or fault case.

Furthermore, a fault case can generally be understood as meaning an improper state of the energy storage with regard to predeterminable criteria. A fault case can be, for example, a malfunction, an improper behavior or a defect in a component of the energy storage device, for example a mechanical defect, such as damage, a leak in a cooling system, a break in a component, a cable break, or the like, or an electrical defect, for example a failure of a sensor, a short circuit, or similar, a departure from a target range of a parameter, e.g. a temperature limit value of a cell temperature or battery temperature being exceeded, an overpressure in a component, or an abnormal behavior of a component, such as a gas leak from a battery cell, etc.

The control device can be electrically or communicatively coupled to the at least one first sensor or connected via a connection that allows the transmission of measurement signals from the first sensor to the control device. This connection can be wired or it can also be a wireless communication connection. A wired connection is preferred.

The energy storage is preferably a high-voltage energy storage, for example a high-voltage battery. Especially with high-voltage energy storage devices, it is very advantageous to be able to detect possible faults in a differentiated manner and as early as possible, for example to prevent thermal runaway of cells, especially battery cells, or thermal propagation. The motor vehicle in which the detection arrangement can be used therefore includes the energy storage, which is preferably designed as a high-voltage energy storage, and the underride guard. The underride guard is arranged below the energy storage in relation to a vehicle vertical axis. The energy storage is therefore located in an underbody region of the motor vehicle or is integrated into an underbody assembly. The energy storage can, for example, as explained in more detail later, comprise a storage housing which is arranged directly above the underride guard. The underride guard can, for example, also be attached to the base of such a storage housing, for example screwed on.

The battery storage can comprise multiple battery cells, which can be formed as lithium-ion cells, for example. The energy storage device can also have multiple battery modules, for example in the form of battery banks or cell banks, wherein each battery module can in turn have several such battery cells.

In order to initiate a reaction measure, the control device can be designed to send a suitable control signal to the relevant component executing the reaction measure, which can also be viewed as part of the detection arrangement. This component is also preferably part of the motor vehicle.

At least the first response measure is assigned to the first fault case. This means that also multiple different reaction measures can be assigned to the first fault case. The same applies to the second fault case. Not all reaction measures that are assigned to the first fault case have to be different from those that are assigned to the second fault case. However, at least one first reaction measure is assigned to the first fault case, which is not assigned to the second fault case and therefore differs from all second reaction measures assigned to the second fault case.

In addition, it is also conceivable that the control device can distinguish not only between two different fault cases, but also between more than two fault cases. The distinction can be based on the evaluation of the measurement signal received by at least one first sensor. In other words, depending on this received measurement signal, the control device can decide whether a fault is present or not, and if a fault is present, the control device can also specify the fault among several possible defined fault cases. The control device can then identify the detected fault case, for example, as the defined first fault case or the defined second fault case. The control device can then initiate the correspondingly assigned reaction measures.

In an advantageous embodiment of the invention, the first and second fault cases differ in terms of their type and/or severity. However, the fault cases can also differ in terms of their position and/or the affected component of the energy storage device. If the first and second fault cases differ, for example in terms of their type, the control device is designed to detect the type of detected fault case depending on the at least one received measurement signal and to determine accordingly whether the first or second fault case is present. However, this does not necessarily have to be the case. For example, the control device can also only be designed to determine, depending on the detected measurement signals, that a fault is present and also to assign them to a corresponding severity according to predetermined criteria depending on the at least one detected measurement signal. Different severity classes can be defined, for example two different classes, such as minor faults and serious faults, or even more than two classes, wherein basically any number of gradations between a serious fault and a light fault, for example a moderately serious fault, is possible. Several different faults, i.e. faults that differ in their type, can also be assigned to the same severity class. The differentiation of fault cases in terms of their severity is particularly advantageous because, on the one hand, the type of fault does not have to be precisely determined, which means that the sensors for fault detection and evaluation can be made simpler, and on the other hand, reaction measures adapted to the severity of a detected fault case are particularly advantageous. The reaction measures can then differ, for example, with regard to the extent of the restrictions on the operating functions of the motor vehicle. A serious fault, that is, if a detected fault is classified as severe or is assigned to a fault class for serious faults, can be assigned a reaction measure that results in a very severe restriction on the use of the motor vehicle and may even make operation of the motor vehicle impossible, while the classification of a fault as a minor fault does not have to result in any restrictions on the use of the motor vehicle, at least temporarily, but only results in the issuance of a message to the driver as a reaction measure.

According to a further advantageous embodiment of the invention, the at least one sensor is designed as at least one temperature sensor and/or as at least one deformation and intrusion sensor for detecting a deformation of the underride guard and/or for detecting an intrusion of an object into or through the underride guard, and/or as at least one harmful gas sensor for detecting harmful gases emerging from the energy storage, and/or as at least one moisture and/or liquid sensor for detecting moisture and/or liquid on the underride guard.

Using these sensors, numerous possible fault cases can be detected and differentiated from one another. For example, if an object hits the underride guard from below and there is an associated deformation or even an intrusion, this can be detected by the deformation and/or intrusion sensor. This can, for example, be designed in the form of a conductor track that is arranged on the underride guard or is integrated into it, and a change in a detected electrical quantity of this conductor track, which can be supplied with current for measuring purposes, can cause the detection of a deformation and/or intrusion. A gas leak from the energy storage can advantageously be detected using a harmful gas sensor. Such a sensor can be designed to detect certain gases or to determine the gas composition or to detect a change in the gas composition compared to a standard composition or the like. The escape of harmful gases from the energy storage is a strong indication of a thermal runaway of a cell in the energy storage. This can thus be reliably detected. A liquid and/or moisture sensor can be used, for example, to detect when a cooling device of the energy storage device has a leak. This may, for example, have been the result of an intrusion that was detected with the deformation and intrusion sensor. This shows that it is precisely a joint evaluation of several different measurement signals from different sensors that enables particularly reliable and differentiated detection of faults.

It is therefore preferred that the detection arrangement comprises a plurality of first sensors, and that the control device is designed to determine, depending on a plurality of measurement signals provided by the respective first sensors, whether the first or the second fault case is present. The control device can also be designed for a combined evaluation of the measurement signals provided. A possible fault detected on the basis of a first measurement signal can, for example, be verified by evaluating a further measurement signal from another sensor or can be classified as even more likely to occur. The underride guard can, for example, include all of the sensors mentioned above. In addition, the underride guard can even include multiple sensors of the same sensor type, for example multiple temperature sensors or gas sensors. These can also be arranged distributed over the surface of the underride guard. As a result, a large region of the underride guard, in particular the entire area of the underride guard, can be monitored using sensors. This means that faults can not only be detected, but also localized, for example. The deformation and intrusion sensor can also be arranged over a large area over the underride guard, for example in the form of the above-mentioned conductor wire. This means that any area of the underride guard or even the entire underride guard can be monitored. Multiple moisture and/or liquid sensors can also be provided. These can be integrated into the temperature sensor.

In a further advantageous embodiment of the invention, the detection arrangement has the energy storage, which comprises a storage housing with a housing base and a plurality of storage cells arranged in the storage housing, wherein the detection arrangement has a gas discharge channel for discharging noxious gas emerging from a storage cell, wherein at least part of the gas discharge channel is provided by a space between the underride guard and the housing base. For example, the storage cells can each have a releasable cell degassing opening, which opens automatically due to pressure, for example, when the internal cell pressure becomes too high to allow gases to escape from the cell. Such cell degassing openings can, for example, be positioned in the respective cells so that they face the housing base of the storage housing. The storage housing base can in turn be designed with predetermined breaking points in order to enable the harmful gas to be introduced into the space between the housing base and the underride guard. This is particularly advantageous because not only it is particularly advantageously possible to remove harmful gases from the motor vehicle, namely in a direction away from the passenger interior, but also because the gas can be removed through the space between the underride guard, in which the at least one first sensor is integrated and the housing base. A gas escape from a cell can then be detected, for example, by means of the above-mentioned gas sensor or additionally or alternatively also by means of a temperature sensor arranged on the underride guard, since these harmful gases emerging from a cell are typically very hot, at least initially.

In a further advantageous embodiment of the invention, the control device is designed to detect the first and/or second fault case, or optionally further fault cases, additionally as a function of a second measurement signal, which can be provided by at least one second sensor, which is arranged within the energy storage. As described at the beginning, an energy storage device can also include sensors, for example temperature sensors, pressure sensors, gas sensors, voltage sensors, current sensors or similar. Such sensors can also advantageously be used to detect and/or differentiate fault cases or to classify them in terms of their severity or to determine the probability of their occurrence more precisely or reliably.

In the same way, it is advantageous if the control device is designed to additionally detect the first and/or second fault case as a function of a third measurement signal, which can be provided by at least one third sensor, which represents a motor vehicle sensor outside the energy storage and outside the underride guard or underride guard region. In particular, other motor vehicle sensors can also advantageously be used for even more precise fault determination. For example, crash sensors can be used to detect whether an accident has just occurred. Environmental sensors of the motor vehicle can be used, such as ambient sensors, for example an external camera, for example to detect smoke or the like. This allows a more precise determination of what type of fault is present and/or to determine how severe the detected fault is.

In a further advantageous embodiment of the invention, the at least one first and second fault case each represents at least one of the following faults: damage to a cooling device of the energy storage device and/or leakage of cooling liquid from the cooling device, an intrusion of an object into the energy storage device, a mechanical deformation of the energy storage, in particular of the storage housing, an abnormal cell state of a storage cell, in particular a state parameter lying outside a certain target range, for example a cell temperature and/or a cell pressure, outgassing of at least one storage cell of the energy storage, and a thermal runaway of one or more storage cells of the energy storage. Outgassing of a storage cell is here understood to mean the escape of a harmful gas from such a storage cell. The control device can also be designed to additionally localize the fault in the event that such a fault is detected. This is possible thanks to the spatially extended sensor arrangement of the underride guard, as described above.

This means that many different faults, in particular a thermal runaway of a battery cell, can be advantageously detected in different stages of such a process. This means that particularly adapted reaction measures can now advantageously be initiated.

Therefore, it represents a further advantageous embodiment of the invention if the first and second reaction measures each represent at least one of the following: outputting information on an output device, in particular to a user or driver of the motor vehicle, wherein the output device can be part of the motor vehicle or can be associated to a user or owner or another authorized person assigned to the motor vehicle, for example an assigned mobile communication device of the user or the authorized person. Another possible measure is a safety shutdown of the entire energy storage system, in particular an entire high-voltage electrical system of the motor vehicle. Further possible measures include a safety shutdown of only a single battery bank of multiple energy banks included in the energy storage or many but not all the energy banks, an increase of a cooling capacity of a cooling device for cooling the energy storage device, in particular by increasing a cooling capacity in a sub-region of the cooling device, which belongs to a sub-region of the energy storage device for which the fault was detected or localized, or increasing a cooling power for increased cooling of the entire energy storage device, reducing the power of consumers of the motor vehicle and/or limiting the total power that can be extracted from the energy storage device, limiting a charging power for electrical charging of the energy storage device on a charging device external to the vehicle, interrupting and/or preventing such a charging process for charging the energy storage device, initiating a extinguishing measure, in particular a flooding the energy storage device.

This is only an exemplary list of possible measures, but should not be understood as an exhaustive list. Other measures are also conceivable, such as automatically sending an eCall, driving the vehicle autonomously out of a closed interior, for example from a garage to the outside, if there is a risk of thermal runaway of the energy storage device, or similar. Depending on the level of autonomy of the motor vehicle, automatic driving of the motor vehicle to a workshop or automatic driving to a safe parking position, for example a remote parking space, is also conceivable. These measures can now advantageously be assigned to corresponding detectable fault cases. Depending on the severity of a fault, an adapted, more or less drastic measure can be initiated. It is also conceivable to simultaneously initiate several of the measures mentioned for a detected fault.

It is also particularly advantageous if information is output to the user as a reaction measure, for example in both fault cases, wherein however the information output differs. This allows, for example, intelligent and situation-adapted action recommendations to be issued to the user.

An example of a smart recommendation for action to the user of a motor vehicle or a service technician in the workshop could look like this: The driver of the motor vehicle first runs over a large object that is lying on the road. The measurement technology in the underride guard comprising the at least one first sensor detects, for example, a deformation that suggests possible cell damage and/or cooling damage. A few minutes later, the gas sensor, which is integrated into the underride guard, detects an abnormal organic solvent content in the underride guard region or a water sensor detects water. There is then a suspicion of cell venting, namely outgassing, of a cell or a ruptured burst disk. However, cell voltages and cell temperatures behave unremarkably within the first 60 minutes. In this case, the user or driver of the vehicle can first receive a notification to visit a service workshop. This notice can be issued via an output option within the motor vehicle. At the same time, the driver is informed that no battery charging or only charging with very low current is permitted, for example no DC fast charging is permitted (direct current fast charging). It is also recommended to park in a “safe” area in order to exclude collateral damage to property or even people. If the high-voltage battery remains inconspicuous, the user can visit the workshop on the next working day. Alternatively, the vehicle can also drive autonomously to the workshop without anyone on board if it is capable of autonomous driving. If the condition of the high-voltage battery changes, the vehicle will be picked up by the workshop at the parking location and taken in for repairs.

Alternative options for action depending on the severity and driving condition of the vehicle can include, for example, a safety shutdown of the entire high-voltage battery system, a safety shutdown of a battery bank to minimize cell load, an increase of the cooling capacity, especially as a preventative measure, in the affected region or the entire battery, or a reduction of performance.

Furthermore, the detection of faults and/or the initiation of measures can take place both when the vehicle is at a standstill, i.e. when the vehicle is parked and without passengers, and also while driving or in an active operating state, for example also during a charging process. or similar. In principle, any operating state of the vehicle, be it active or inactive, can be monitored. A user of the vehicle does not necessarily have to be present.

Furthermore, the invention also relates to a motor vehicle having a detection arrangement according to the invention or one of its embodiments.

The invention relates to a method for detecting a possible fault in an energy storage of a motor vehicle, by means of a detection arrangement comprising an underride guard, at least one first sensor arranged on the underride guard or integrated into the underride guard, and a control device which is designed to detect at least two different specific possible fault cases comprising a possible first fault case and a possible second fault case and, depending on a measurement signal received from the at least one first sensor, determining whether the possible first fault case is present or whether the possible second fault case is present. At least one first reaction measure is assigned to the first fault case and at least one second reaction measure is assigned to the possible second fault case, which second reaction measure differs from the first reaction measure, wherein the control device is designed to initiate the first reaction measure if the control device has determined that the possible first fault case is present, and to initiate the second reaction measure if the control device has determined that the possible second fault case is present.

For applications or usage situations that can arise in the method and which are not explicitly described here, it can be provided according to the method, that a fault message and/or a request for input of user feedback is output and/or a standard setting and/or a predetermined initial status are set.

The control device for the motor vehicle is also part of the invention. The control device can have a data processing device or a processor device which is set up to perform an embodiment of the method according to the invention. For this purpose, the processor device can have at least one microprocessor and/or at least one microcontroller and/or at least one FPGA (Field Programmable Gate Array) and/or at least one DSP (Digital Signal Processor). Furthermore, the processor device can have program code which is configured to carry out the embodiment of the method according to the invention when it is executed by the processor device. The program code can be stored in a data memory of the processor device. The processor device can be based, for example, on at least one circuit board and/or at least one SoC (System on Chip).

The invention also includes developments of the method according to the invention, which have features as have already been described in conjunction with the developments of the detection arrangement according to the invention. For this reason, the corresponding developments of the method according to the invention are not described again here.

The motor vehicle according to the invention is preferably designed as an automobile, in particular as a passenger car or truck, or as a passenger bus or motorcycle.

The invention also comprises the combinations of the features of the described embodiments. The invention therefore also comprises implementations that respectively have a combination of the features of several of the described embodiments, provided that the embodiments have not been described as mutually exclusive.

### BRIEF DESCRIPTION OF THE FIGURES

Exemplary embodiments of the invention are described hereinafter. In the figures:

FIG. 1 shows a schematic representation of a motor vehicle according to an exemplary embodiment of the invention; and

FIG. 2 shows a schematic representation of a detection arrangement according to an exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, the same reference numerals respectively designate elements that have the same function.

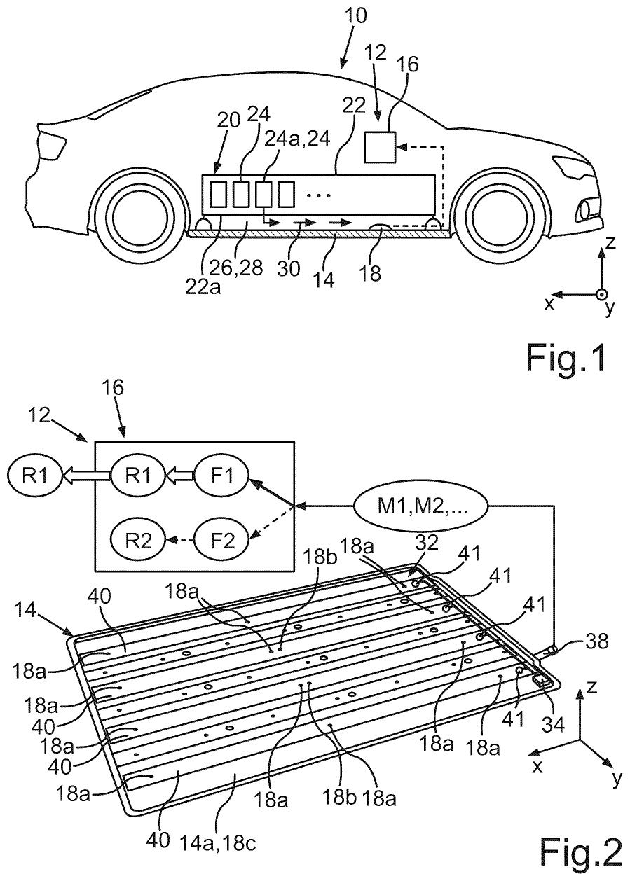

FIG. 1 shows a schematic illustration of a motor vehicle 10 according to an exemplary embodiment of the invention. The motor vehicle 10 comprises a detection arrangement 12 according to an exemplary embodiment of the invention. This has an underride guard 14 as part of the motor vehicle 10, as well as a control device 16. The underride guard 14 in turn comprises at least one sensor 18, which can be integrated into the underride guard 14 or can be arranged on it in some way. Furthermore, the motor vehicle 10 has an energy storage device 20, in this example in the form of a high-voltage battery 20. The energy storage 20 comprises a storage housing 22 in which multiple battery cells 24, for example lithium-ion cells, are arranged. A base 22a of the storage housing 22 faces the underride guard 14. Between the underride guard 14 and the base 22a of the storage housing 20 there can be a space 26, which can be used at least partially as a gas discharge channel 28 in the event of gas escaping from a cell 24. The gases emerging here as an example from a thermally runaway battery cell 24a are illustrated by the arrows 30. The at least one sensor 18 can have different characteristics and, based on the evaluation of such sensor signals, numerous different fault cases can be detected, which in turn makes it possible to initiate adapted reaction measures. This will now be explained in more detail with reference to FIG. 2.

FIG. 2 shows a schematic illustration of a detection arrangement 12 for a motor vehicle 10 according to an exemplary embodiment of the invention. The detection arrangement 12 can in particular be designed as already described above for FIG. 1. The underride guard 14 is shown here again in a perspective view diagonally from above. This underride guard 14 can, for example, have a length in the x direction of two meters and a width in the y direction of, for example, 1.3 meters. This can in particular also correspond to the dimensions of the energy storage 20 in the x and y directions. Numerous sensors 18, such as twelve combination sensors 18a, are now integrated on this underride guard 14 or in this underride guard 14, in each of which a temperature sensor 18a and a moisture or liquid sensor 18a can be integrated, for example for detecting water, glycol, leaking coolant or the like can be. Furthermore, the underride guard 14 includes two gas sensors 18b. In the wall 14a of the underride guard 14, which separates the vehicle 10 from the environment, a resistance wire can be woven and laminated as part of an intrusion and deformation sensor 18c, for example in an underride guard 14 made of fiber-reinforced plastic or in a wall 14a made of fiber-reinforced plastic.

In addition, this sensor arrangement 32 can include a measurement front end 34, to which the measurement signals from the individual sensors 18a, 18b, 18c are routed via appropriately laid lines. This measuring front end 34 can be designed as a measuring transducer, for example as an analog-digital converter. This can forward the measurement signals to the control device 16 via a corresponding plug 38. The plug 38 can be designed, for example, as an eight-pin plug. The individual sensors 18a, 18b, 18c can be arranged on corresponding conductor tracks or flexible circuit boards 40. In this example they are shown as, for example flexible, circuit boards 40 elongated in the x direction. The high-voltage battery 20 can, for example, have four battery modules elongated in the x direction, one of which can respectively be arranged above such a circuit board 40 in the z direction.

The sensor lines to the measuring transducer 34 can also be laid on and along these circuit boards 40, for example up to a respective tapping point 41 at the end of a respective circuit board, and from there via suitable cables or lines to the measurement front end 34. The control device 16 evaluates the received measurement signals M1, M2 and so on, of the various sensors 18a, 18b, 18c as well as optionally further measurement signals, for example from sensors that are integrated into the energy storage 20 itself, or sensors of the motor vehicle 10 in general. Depending on a result of this evaluation, the control device 16 can, for example, determine whether there is a fault in the energy storage 20 or not. In the event that it is determined that such a fault is present, the control device 16 can also distinguish, for example, whether it is a specific first fault F1, a specific second fault F2, or optionally also a third, fourth, fifth fault, and so on. In other words, the control device 16 can also classify a detected fault in terms of its type and/or severity. In the present example, the control device 16 detects the first fault F1 based on the evaluation of the measurement signals M1, M2. A first reaction measure R1 is also assigned to this first fault F1. The control device 16 triggers this first reaction measure R1, which is therefore assigned to the first detected fault FL. If the control device 16 instead detects a second defined fault F2, it would trigger at least one second reaction measure R2 assigned to this second fault F2, which is different from the first reaction measure R1.

This therefore enables a particularly suited initiation of reaction measures to detected faults in the energy storage 20. The control device 16 can be implemented, for example, by a battery management controller and/or another vehicle computer. It would also be conceivable to design the control device 12 as a control device external to the vehicle, for example in a cloud. The evaluation of the measurement signals M1, M2 can therefore also be carried out externally to the vehicle and the result of the evaluation can be transmitted to the vehicle 10, which then carries out the corresponding reaction measure R1.

Overall, the examples show how the invention can provide intelligent underride guard with a sensor cluster to generate big data. The invention thus enables smart action recommendations for the safe operation and handling of the electric vehicle, in particular a battery-electric vehicle. The measurement of temperature, humidity, deformation or intrusion and harmful gases are used. This makes it possible, for example, to prevent DC fast charging if there is a suspicion of loss of cooling function or impairment of the cells due to damage or an event. This in turn generally enables automated preventative self-protection functions of the vehicle system, especially of the high-voltage battery. This means that what is happening in the field can be better assessed.

1. A detection arrangement for detecting a possible fault case of an energy storage of a motor vehicle, comprising:
an underride guard,
at least one first sensor arranged on the underride guard or integrated into the underride guard,
a control device which is designed to detect at least two different specific possible fault cases, comprising a possible first fault case and a possible second fault case, and depending on a measurement signal received from the at least one first sensor, to determine whether the possible first fault case is present or whether the possible second fault case is present,
at least one first reaction measure is assigned to the possible first fault case and at least one second reaction measure, which differs from the first reaction measure, is assigned to the possible second fault case,
wherein the control device is designed to initiate the first reaction measure if the control device has determined that the possible first fault case is present, and to initiate the second reaction measure if the control device has determined that the possible second fault case is present.

2. The detection arrangement according to claim 1, wherein the possible first and possible second fault case differ in terms of their type and/or severity.

3. The detection arrangement according to claim 1, wherein the at least one first sensor is designed as:
at least one temperature sensor; and/or
at least one deformation and intrusion sensor for detecting a deformation of the underride guard and/or the intrusion of an object into or through the underride guard; and/or
at least one harmful gas sensor for detecting harmful gases emerging from the energy storage; and/or
at least one moisture and/or liquid sensor for detecting moisture and/or liquid on the underride guard.

4. The detection arrangement according to claim 1, wherein the detection arrangement has the energy storage, which comprises a storage housing with a housing base, and multiple storage cells arranged in the storage housing, wherein the detection arrangement has a gas discharge channel for discharging harmful gas emerging from at least one of the storage cells, wherein at least part of the gas discharge channel is provided by a space between the underride guard and the housing base.

5. The detection arrangement according to claim 1, wherein the detection arrangement comprises multiple first sensors, and the control device is designed to determine, depending on multiple measurement signals provided by the respective first sensors, whether the possible first or the possible second fault case is present.

6. The detection arrangement according to claim 1, wherein the control device is designed to detect the first and/or second possible fault case, additionally as a function of a second measurement signal which can be provided by at least one second sensor which is arranged within the energy storage.

7. The detection arrangement according to claim 1, wherein the at least one possible first and possible second fault case each represent at least one of the following fault cases:
damage to a cooling device of the energy storage device and/or leakage of cooling liquid from the cooling device;
an intrusion of an object into the energy storage;
a mechanical deformation of the energy storage, in particular of the storage housing;
an abnormal cell state of a storage cell, in particular a state parameter lying outside a predetermined target range, for example a cell temperature and/or a cell pressure;
an outgassing of at least one storage cell of the energy storage;
a thermal runaway of one or more storage cells of the energy storage.

8. The detection arrangement according to claim 1, wherein the first and second response measures each represent at least one of the following:
outputting information on an output device, in particular of the motor vehicle or a mobile communication device assigned to a user or owner of the motor vehicle;
safely shut-down of the entire energy storage device, in particular an entire high-voltage electrical system of the motor vehicle;
safely shut-down of a battery bank of multiple energy banks included in the energy storage;
increasing a cooling performance of a cooling device for cooling the energy storage, in particular increasing a cooling performance in a sub-region of the cooling device, which corresponds to a sub-region of the energy storage for which the possible fault case was detected, or increasing a cooling capacity for increased cooling of the entire energy storage device;
reducing the performance of consumers of the motor vehicle and/or limiting the total power that can be extracted from the energy storage device;
limiting a charging power for charging the energy storage;
interrupting and/or preventing a charging process for charging the energy storage device;
initiating an extinguishing measure, in particular flooding the energy storage.

9. A motor vehicle with a detection arrangement according to claim 1.

10. A method for detecting a possible fault case of an energy storage of a motor vehicle by a detection arrangement comprising:
an underride guard,
at least one first sensor arranged on the underride guard or integrated into the underride guard,
a control device which is designed to detect at least two different specific possible fault cases, comprising a possible first fault case and a possible second fault case, and depending on a measurement signal received from the at least one first sensor, to determine whether the possible first fault case is present or whether the possible second fault case is present, and
at least one first reaction measure is assigned to the possible first fault case and at least one second reaction measure, which differs from the first reaction measure, is assigned to the possible second fault case,
wherein the control device initiates the first reaction measure if the control device has determined that the possible first fault case is present, and initiates the second reaction measure if the control device has determined that the possible second fault case is present.

11. The detection arrangement according to claim 2, wherein the at least one first sensor is designed as:
at least one temperature sensor; and/or
at least one deformation and intrusion sensor for detecting a deformation of the underride guard and/or the intrusion of an object into or through the underride guard; and/or
at least one harmful gas sensor for detecting harmful gases emerging from the energy storage; and/or
at least one moisture and/or liquid sensor for detecting moisture and/or liquid on the underride guard.

12. The detection arrangement according to claim 2, wherein the detection arrangement has the energy storage, which comprises a storage housing with a housing base, and multiple storage cells arranged in the storage housing, wherein the detection arrangement has a gas discharge channel for discharging harmful gas emerging from at least one of the storage cells, wherein at least part of the gas discharge channel is provided by a space between the underride guard and the housing base.

13. The detection arrangement according to claim 3, wherein the detection arrangement has the energy storage, which comprises a storage housing with a housing base, and multiple storage cells arranged in the storage housing, wherein the detection arrangement has a gas discharge channel for discharging harmful gas emerging from at least one of the storage cells, wherein at least part of the gas discharge channel is provided by a space between the underride guard and the housing base.

14. The detection arrangement according to claim 2, wherein the detection arrangement comprises multiple first sensors, and the control device is designed to determine, depending on multiple measurement signals provided by the respective first sensors, whether the possible first or the possible second fault case is present.

15. The detection arrangement according to claim 3, wherein the detection arrangement comprises multiple first sensors, and the control device is designed to determine, depending on multiple measurement signals provided by the respective first sensors, whether the possible first or the possible second fault case is present.

16. The detection arrangement according to claim 4, wherein the detection arrangement comprises multiple first sensors, and the control device is designed to determine, depending on multiple measurement signals provided by the respective first sensors, whether the possible first or the possible second fault case is present.

17. The detection arrangement according to claim 2, wherein the control device is designed to detect the first and/or second possible fault case, additionally as a function of a second measurement signal which can be provided by at least one second sensor which is arranged within the energy storage.

18. The detection arrangement according to claim 3, wherein the control device is designed to detect the first and/or second possible fault case, additionally as a function of a second measurement signal which can be provided by at least one second sensor which is arranged within the energy storage.

19. The detection arrangement according to claim 4, wherein the control device is designed to detect the first and/or second possible fault case, additionally as a function of a second measurement signal which can be provided by at least one second sensor which is arranged within the energy storage.

20. The detection arrangement according to claim 5, wherein the control device is designed to detect the first and/or second possible fault case, additionally as a function of a second measurement signal which can be provided by at least one second sensor which is arranged within the energy storage
